(19) United States
(12) Patent Application Publication
(10) Pub. No.: US 2005/0276240 A1
(43) Pub. Date: Dec. 15, 2005

(54) Scheme for seamless connections across heterogeneous wireless networks

(76) Inventors: Vivek G. Gupta, Portland, OR (US); Christian Maciocco, Tigard, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/856,385

(22) Filed: May 27, 2004

(51) Int. Cl. H04Q 7/00

(52) U.S. Cl. 370/328

(57) ABSTRACT

A method and apparatus supporting virtual connections over heterogeneous wireless networks is disclosed. A virtual connection manager on a first device provides a communication path between an application on the apparatus and a second device via a wireless link. The virtual connection manager can change the wireless link to another wireless link without closing the communication path.

### BACKGROUND

Description of the Related Art

In advancing wireless technology, a single device may be able to communicate over two or more different kinds of wireless links. Each of these links may implement a different wireless air link protocol, and distinct types of hardware and software may be used to support the various protocols. The networks formed by the different types of links are considered heterogeneous networks, meaning that the hardware and software associated with one of the links cannot typically be used to make connections across another link. The choice of which communication link to use may be determined based on proximity to an access point, strength of a signal, available bandwidth, user or service provider based policies, and other such conditions.

### BRIEF DESCRIPTION OF THE DRAWINGS

The present invention may be better understood, and its numerous features and advantages made apparent to those skilled in the art by referencing the accompanying drawings.

FIG. 1 illustrates a block diagram of a wireless system with multiple heterogeneous networks according to an embodiment of the present invention.

FIG. 2 illustrates portions of a wireless device with support for virtual connections over heterogeneous wireless networks according to an embodiment of the present invention.

FIG. 3 illustrates a flow diagram according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” and the like, indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” and the like, to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

Types of wireless communication systems intended to be within the scope of the present invention include, although not limited to, Wireless Local Area Network (WLAN), Wireless Wide Area Network (WWAN), Wireless Personal Area Network (WPAN), Wireless Metropolitan Area Network (WMAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, Universal Mobile Telecommunications System (UMTS), and the like, although the scope of the invention is not limited in this respect.

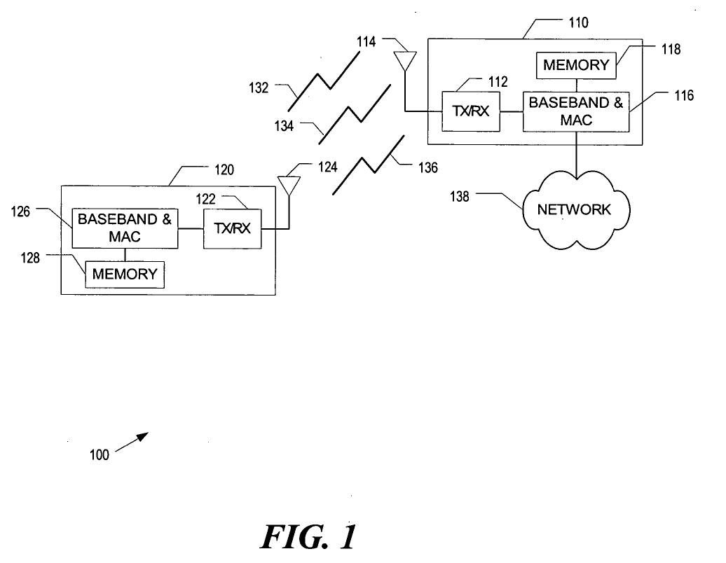

FIG. 1 illustrates a block diagram of a wireless system with multiple wireless networks according to an embodiment of the present invention. In the wireless system 100 shown in FIG. 1, a first device 110 may include a wireless transceiver 112 to couple to an antenna 114 and to a baseband processor 116. Baseband processor 116 in one embodiment may include a single processor, or alternatively may include a baseband processor and an applications processor, although the scope of the invention is not limited in this respect. Baseband processor 116 may couple to a memory 118 which may include volatile memory such as DRAM, non-volatile memory such as flash memory, or alternatively may include other types of storage such as a hard disk drive, although the scope of the invention is not limited in this respect. Some portion or all of memory 118 may be included on the same integrated circuit as baseband processor 116, or alternatively some portion or all of memory 118 may be disposed on an integrated circuit or other medium, for example a hard disk drive, that is external to the integrated circuit of baseband processor 116, although the scope of the invention is not limited in this respect.

First device 110 communicates to a second device 120, at least one of which may be a mobile unit (MU). Second device 120 may include a transceiver 122, antenna 124, baseband processor 126, and memory 128. In some embodiments, first device 110 and second device 120 may transmit and/or receive one or more packets over wireless system 100 via antennas 114 and 124. Alternatively, first device 110 and second device 120 may include two or more antennas to provide a diversity antenna arrangement, to provide spatial division multiple access (SDMA), or to provide a multiple input, multiple output (MIMO) system, or the like, although the scope of the invention is not limited in this respect. The packets may include data, control messages, network information, and the like.

First device 110 and second device 120 may be any of various devices, such as a cellular telephone, wireless telephone headset, printer, wireless keyboard, mouse, wireless network interface devices and network interface cards (NICs), base stations, access points (APs), gateways, bridges, hubs, cellular radiotelephone communication systems, satellite communication systems, two-way radio communication systems, one-way pagers, two-way pagers, personal communication systems (PCS), portable or stationary personal computers (PCs), personal digital assistants (PDAs), software defined radios, reconfigurable radios, or other device capable of communicating over a wireless network. Additionally or alternatively, in other embodiments of the present invention, wireless communication system 100 may include additional devices, any of which may be mobile units.

First device 110 may couple with network 138 so that first device 110 and second device 120 may communicate with network 138, including devices coupled to network 138. Network 138 may include a public network such as a telephone network or the Internet, or alternatively network 138 may include a private network such as an intranet, or a combination of a public and a private network, although the scope of the invention is not limited in this respect.

First device 110 and second device 120 may communicate with each other via one of multiple wireless communication links, for example links 132, 134 and 136. Each of these links may implement a different wireless air link protocol, and distinct types of hardware and software may be used to support the various protocols. For example, transceiver 112 and antenna 114 may include multiple transceivers and antennas for communicating via the multiple wireless communication links. The choice of which communication link to use may be determined based on proximity to the other device, strength of a signal, available bandwidth, cost of wireless spectrum, user or system level policies, and other such conditions.

Links 132, 134 and 136 may be implemented in accordance with various wireless standards including, for example, one or more wireless cellular standards, one or more wireless networking standards, one or more radio frequency identification (RFID) standards, and/or others. The different networks formed by links 132, 134 and 136 are considered heterogeneous networks, meaning that the hardware and software associated with one of the links cannot typically be used to make connections across another link. In at least one implementation, for example, at least one link is implemented in accordance with the Bluetooth short range wireless protocol (Specification of the Bluetooth System, Version 1.2, Bluetooth SIG, Inc., November 2003, and related specifications and protocols). Other possible wireless networking standards include, for example: IEEE 802.11 (ANSI/IEEE Std 802.11-1999 Edition and related standards), HIPERLAN 1, 2 and related standards developed by the European Telecommunications Standards Institute (ETSI) Broadband Radio Access Networks (BRAN), HomeRF (HomeRF Specification, Revision 2.01, The HomeRF Technical Committee, July, 2002 and related specifications), and/or others.

In one embodiment of the present invention, a communication path is established for an application operating on first device 110 to second device 120 via wireless link 132. The communication path includes a virtual application connection to the application and a network connection via wireless link 132. The communication environment changes, for example, if first device 110 is a mobile device and begins moving out of a range capable of communicating via link 132. First device 110 switches the communication path to wireless link 134 without closing the virtual application connection.

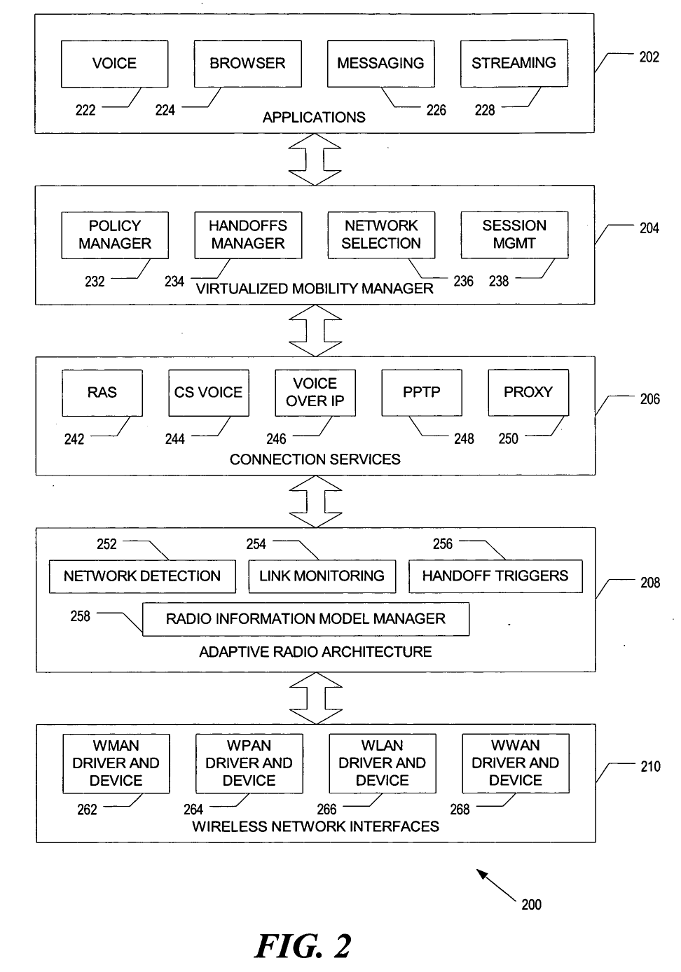

FIG. 2 illustrates portions of a wireless device with support for virtual connections over heterogeneous wireless networks according to an embodiment of the present invention. In one embodiment, wireless system 200 includes applications 202, virtualized mobility manager 204, connection services 206, an adaptive radio architecture 208 and wireless network interfaces 210.

Wireless system 200 supports several network points of attachments and has knowledge of network elements involved in a communication path. Thus, wireless system 200 has routing information about a particular communication path, and this knowledge allows wireless system 200 to determine boundaries between various networks and to switch connections to the most appropriate network and wireless link. Applications 202 open a single virtual communication path to another device. The communication path includes a virtual application connection to the application and a network connection via a wireless link.

Wireless system 200, for example, first device 110, includes one or more higher layer user level applications 202, such as, for example but not by way of limitation, voice application 222, browser application 224, messaging application 226, and streaming application 228. Other applications may include telephony, synchronization, printing, file transfer, cellular data services such as messaging services, multimedia messaging services, and the like. Applications 202 operating on wireless system 200 receive or send data to another device, for example, second device 120. As the communication environment changes or for other various reasons, the wireless link, for example, wireless line 132 carrying the data between first device 110 and second device 120 may be switched to another wireless link, for example to wireless link 134.

Virtualized mobility manager 204 establishes and manages virtual connections between applications 202 and different types of wireless network interfaces 210. Applications 202 need only open or close the virtual application connection once, even when the communication path switches between multiple wireless links. Virtualized mobility manager 204 abstracts connection knowledge of applications 202 and provides non-changing connection parameters to applications 202.

Virtualized mobility manager 204 includes a connection policy manager 232, a handoffs manager 234, a network selection manager 236, and a session manager 238. Connection policy manager 232 allows applications 202 to indicate their preferences for managing connections. Some of these parameters include cost of connection, priority, required bandwidth, maximum latency, exclusiveness of connection, duration, security needs, and the like. Based on these preferences, virtualized mobility manager 204 makes appropriate connection choices between different available wireless networks. Network selection manager 236 allows virtual mobility manager 204 to select different available wireless networks based on link properties. Handoffs manager 234 and session manager 238 manage roaming decisions and session handoffs across different wireless networks based on user policies and notification of handoff triggers from radio information model manager 208.

In one embodiment, connection services 206 can support local and remote connections using well-known techniques such as remote access server (RAS) 242, circuit switched (CS) voice unit 244, voice over internet protocol (IP) unit 246, point-to-point tunneling protocol (PPTP) unit 248, proxy unit 250, and other such techniques. For example, voice application 222 may use a CS voice 244 or a voice over IP 246 type of connection.

Adaptive radio architecture 208 includes, for example, a network detection unit 252, a link monitoring unit 254, a handoff triggers unit 256, and a radio information model manager (RIMM) 258. RIMM 258 supports a set of services, for example, network detection unit 252, link monitoring unit 254, and handoff triggers unit 256. RIMM 258 acts as a central point for accessing all physical and link layer properties of different wireless devices and protocols and exposes this information in a consistent manner across platform and operating systems to drivers, middleware radio services, and/or mobile aware applications. RIMM 258 is designed to support multiple discrete as well as reconfigurable radio devices across a wide variety of wireless protocols.

Wireless network interfaces 210 include multiple interfaces, for example, a wireless metropolitan area network (WMAN) driver and device interface 262, a wireless personal area network (WPAN) driver and device interface 264, a wireless local area network (WLAN) driver and device interface 266, a wireless wide area network (WWAN) driver and device interface 268 and other such wireless interfaces.

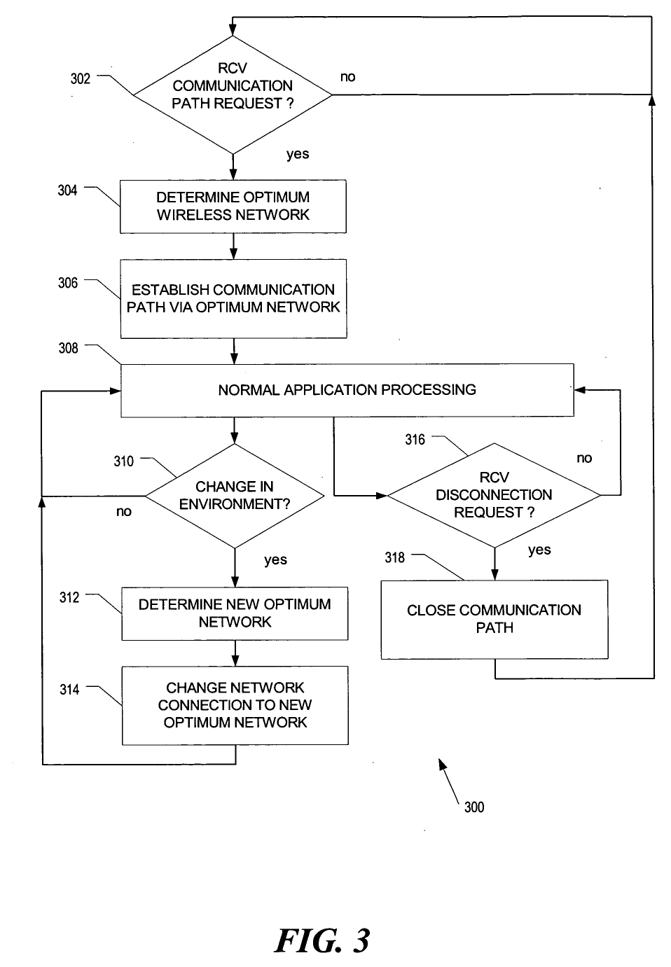

FIG. 3 illustrates a flow diagram according to an embodiment of the present invention. Flow 300 begins with a communication path request received from an application, block 302. An optimum wireless network to connect to is determined, block 304. The choice of optimum wireless network can be according to, for example, distance between devices, signal strength, noise, cost of service, user or system level policies, and the like. A communication path is established via the optimum network, block 306. The communication path includes a virtual application connection to the application and a network connection via the optimum network, that is, a particular wireless link. Normal application processing is performed, step 308. For example, the application may send or receive data along the communication path. A change in environment or other condition is monitored for, step 310. If a change does not occur, normal application processing continues. If a change occurs, a new optimum network is determined, step 312. The network connection is changed to the new optimum network without changing the virtual application connection, step 314. The application is not aware of the change in wireless links. Normal application processing continues, step 308. A disconnection request is monitored for, step 316. If a disconnection request is not received, normal application processing continues, step 308. If a disconnection request is received, the communication path is closed, including closing the virtual application connection and the network connection, step 318.

The techniques described above may be embodied in a computer-readable medium for configuring a computing system to execute the method. The computer readable media may be permanently, in a removable manner, or remotely coupled to first device 110, second device 120, or another system. The computer readable media may include, for example and without limitation, any number of the following: magnetic storage media including disk and tape storage media; optical storage media such as compact disk media (for example, CD-ROM, CD-R, and the like) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, and the like; and data transmission media including permanent and intermittent computer networks, point-to-point telecommunication equipment, carrier wave transmission media, the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few. A typical computing system includes at least one processing unit, associated memory and a number of input/output (I/O) devices. A computing system processes information according to a program and produces resultant output information via I/O devices.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

1. A method comprising:
establishing a communication path between a first device and a second device, the communication path comprising:
a virtual connection to an application operating on the first device; and
a first network connection via a first wireless link between the first device and a first network; and
closing the first network connection and establishing a second network connection via a second wireless link between the first device and a second network without closing the virtual connection;
wherein the second device is coupled to the first network and the second network.

2. The method as recited in claim 1, wherein establishing the second network connection comprises determining that the second wireless link provides a more optimum connection than the first wireless link.

3. The method as recited in claim 1, wherein the closing the first network connection and the establishing the second network connection are triggered by a change in a wireless parameter.

4. The method as recited in claim 3, wherein the wireless parameter is a distance between the first device and the second device.

5. The method as recited in claim 3, wherein the change in the wireless parameter is a decrease in a signal strength of the first network.

6. The method as recited in claim 1, wherein the closing the first network connection and the establishing the second network connection are triggered by an availability of a lower cost network.

7. The method as recited in claim 1, wherein the closing the first network connection is performed after the establishing the second network connection.

8. The method as recited in claim 1, wherein the first wireless link is part of a first wireless network and the second wireless link is part of a second wireless network; and wherein the first wireless network and the second wireless network are heterogeneous networks.

9. The method as recited in claim 1, wherein the first wireless link is according to a wireless standard and the second wireless link is according to a different wireless standard.

10. The method as recited in claim 1, wherein the without closing the virtual connection includes allowing current application processing to continue.

11. The claim as recited in claim 1, wherein the establishing the communication path comprises providing the application with virtual connection parameters that do not change when the first network connection is changed to the second network connection.

12. A method comprising:
providing a communication path between an application operating on a first device and a second device via a first wireless link;
identifying a change in a wireless parameter;
changing the communication path to a second wireless link without an interruption in the processing of the application.

13. The method as recited in claim 12, wherein changing the communication path to the second wireless link comprises determining that the second wireless link provides a more optimum connection than the first wireless link.

14. The method as recited in claim 12, wherein the wireless parameter is a distance between the first device and the second device.

15. The method as recited in claim 12, wherein the change in the wireless parameter is a decrease in a signal strength of the first network.

16. The method as recited in claim 12, wherein the change in the wireless parameter is an availability of a lower cost network.

17. The method as recited in claim 12, wherein the first wireless link is according to a wireless protocol and the second wireless link is according to a different wireless protocol.

18. The method as recited in claim 12, wherein the first wireless link is part of a first wireless network and the second wireless link is part of a second wireless network; and wherein the first wireless network and the second wireless network are heterogeneous networks.

19. An apparatus comprising:
a virtual connection manager to provide a communication path between an application and a device via a wireless link;
wherein the virtual connection manager can change the wireless link to another wireless link without closing the communication path.

20. The apparatus as recited in claim 19, further comprising:
a first wireless interface capable of sending data from the application to the device via the wireless link; and
a second wireless interface capable of sending data from the application to the device via the another wireless link

21. The apparatus as recited in claim 19, wherein to change the wireless link to another wireless link comprises to determine that the another wireless link provides a more optimum connection than the wireless link.

22. The apparatus as recited in claim 19, wherein to change the wireless link is triggered by a change in a wireless parameter.

23. The apparatus as recited in claim 22, wherein the wireless parameter is a distance between the apparatus and the device.

24. The apparatus as recited in claim 19, wherein the wireless link is part of a first wireless network and the another wireless link is part of a second wireless network; and wherein the first wireless network and the second wireless network are heterogeneous networks.

25. The apparatus as recited in claim 19, wherein the wireless link is according to a wireless standard and the another wireless link is according to a different wireless standard.

26. A communication device comprising:
one or more antennas to communicate via a first wireless link and a second wireless link;
a virtual connection manager to provide a communication path between an application and a device via the first wireless link;
wherein the virtual connection manager can change the first wireless link to the second wireless link without closing the communication path.

27. The communication device as recited in claim 26, further comprising:
a first wireless interface capable of sending data from the application to the device via the wireless link; and
a second wireless interface capable of sending data from the application to the device via the another wireless link

28. The communication device as recited in claim 26, wherein to change the wireless link to another wireless link comprises to determine that the another wireless link provides a more optimum connection than the wireless link.

29. The communication device as recited in claim 26, wherein to change the wireless link is triggered by a change in a wireless parameter.

30. The communication device as recited in claim 29, wherein the wireless parameter is a distance between the apparatus and the device.

31. The communication device as recited in claim 26, wherein the wireless link is according to a wireless protocol and the another wireless link is according to a different wireless protocol.

32. The communication device as recited in claim 26, wherein the wireless link is part of a first wireless network and the another wireless link is part of a second wireless network; and wherein the first wireless network and the second wireless network are heterogeneous networks.
